(19) United States
(12) Patent Application Publication
(10) Pub. No.: US 2014/0074663 A1
(43) Pub. Date: Mar. 13, 2014

(54) INTEGRATING PURCHASE HISTORY AND METADATA ACROSS DEVICES

(71) Applicants: Thomas Alsina, Mountain View, CA (US); Olagappan Manickam, Cupertino, CA (US); Lucas Newman, San Francisco, CA (US); Ellis Marshall Verosub, San Carlos, CA (US); David Anthony William Pickford, San Jose, CA (US); Nurinder Manj, San Jose, CA (US); Amandeep Jawa, San Francisco, CA (US); Garrick McFarlane, London (GB); Kevin R. Lafferty, San Mateo, CA (US)

(72) Inventors: Thomas Alsina, Mountain View, CA (US); Olagappan Manickam, Cupertino, CA (US); Lucas Newman, San Francisco, CA (US); Ellis Marshall Verosub, San Carlos, CA (US); David Anthony William Pickford, San Jose, CA (US); Nurinder Manj, San Jose, CA (US); Amandeep Jawa, San Francisco, CA (US); Garrick McFarlane, London (GB); Kevin R. Lafferty, San Mateo, CA (US)

(73) Assignee: Apple Inc., Cupertino, CA (US)

(21) Appl. No.: 13/607,765

(22) Filed: Sep. 9, 2012

(51) Int. Cl. G06Q 30/00; G06Q 30/06

(52) U.S. Cl. 705/27.1

(57) ABSTRACT

The technology relates to synchronizing purchase information and metadata across devices. The system maintains a server listing of items purchased from an online store and associated with a user account, each item in the server listing of items being associated with a respective first hash value. Then, the system receives, from a client device, a client listing of items purchased from the online store representing a last known listing of items purchased from the online store and associated with the user account, each item in the client listing of items being associated with a respective second hash value. Next, the system determines a difference between the respective first hash value and the respective second hash value. Based on the difference, the system sends, to the client device, metadata identifying items present in the server listing of items that are not in the client listing of items.

### BACKGROUND

1. Technical Field

The present disclosure relates to online media purchases and, more specifically, to synchronizing purchase history information and metadata across devices.

2. Introduction

During the early 20^{th} Century, the principal way people were able to listen to music was with a vinyl record. Now, people are able to listen to music or watch a movie from their mobile phones, personal players, and laptop computers, by simply playing a digital file stored on the device. Users can conveniently download digital files to their mobile device from the Internet, and play the digital files directly from their mobile device. Not surprisingly, this remarkable convenience and availability of online media has prompted the market for downloadable music and other media to grow widespread. Sales of downloaded music have surpassed sales of physical media in many markets throughout the world. The Internet and the rise of mobile media devices are often cited as the catalyst behind this digital-media surge.

Capitalizing on the digital-media surge, online media stores, such as Apple's iTunes Store, blazed a trail for online media consumption. Online media stores gave users access to extensive online media catalogs, where users can easily purchase and download media from any media device connected to the Internet. And access to such online media catalogs has only grown steadily with the increase and variety of media and Internet capabilities of mobile devices, such as mobile phones, portable media players, and laptop computers, which allow users to purchase and download media from a wider variety of personal devices. The increased access to online media catalogs has also been precipitated by the growing trend of people using a variety of personal devices to access media and the Internet—users frequently own multiple media devices, and use the various media devices to access online media catalogs and purchase media from online media stores. For example, it is not uncommon for a user to purchase and download a song from her mobile phone, and a movie from her laptop computer.

Typically, media purchased from an online media store is stored on the device used by the user to purchase and download the media. Often, the online media store also maintains a list of the items purchased by the user. However, this list of purchased items is not automatically synchronized across other devices used by the user to purchase and download the media. Thus, when a user purchases and downloads media from multiple devices, the different devices will often have a different list of media items stored and accessible from each device. Similarly, user metadata, such as a play count, a play date, a song rating, or a user comment, is generally stored on the device used by the user to generate or edit the user metadata. Therefore, when a user edits or updates user metadata from multiple devices, the different devices will generally have different user metadata stored and accessible from each device. As a result, it is not currently possible to access purchase history information and user metadata stored locally on one device from another device. At best, the user normally can log into an account on the online media store, and navigate to a history of all purchased items using the device that they want the purchased item to be downloaded to, and initiate a manual download of the items in the purchase history. Accordingly, maintaining the most current purchase history and user metadata across different devices can be an onerous task, particularly as the number of devices and media items increase.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to efficiently synchronize purchase history information and user metadata across multiple devices. These approaches can be used to facilitate the integration of metadata across multiple devices, while minimizing the storage and computing requirements to feasible and cost-effective levels. By synchronizing purchase history information and user metadata across multiple devices, the user can obtain a similar media experience from the different devices. Also, the user is spared the time-consuming process of manually copying purchase history information and user metadata from different devices. Moreover, the synchronized user metadata can provide the user a seamless transition when accessing media items from different devices.

Disclosed are systems, methods, and non-transitory computer-readable storage media for synchronizing purchase history information and user metadata across devices. The method is discussed in terms of a system, or elements thereof, implementing the method, such as a server, a laptop, a handheld mobile device, or an online store. In some embodiments, the system maintains a server listing of items purchased from an online store and associated with a user account, each item in the server listing of items being associated with a hash value. The system then receives, from a client device, a client listing of items purchased from the online store representing the last known listing of items purchased from the online store and associated with the user account, each item in the client listing of items being associated with a hash value. A hash value refers to a value obtained by applying a hash function or algorithm to a data set to obtain a smaller data set known as the hash value. The hash value can be based on the item ID, version information, store ID associated with the item, metadata associated with the item, fingerprint associated with the item, name of the item, etc. For example, if an item is an audio file, the hash value can be based on the audio file, the store ID of the audio file, and/or the metadata associated with the audio file. The client device can be configured to send the client listing of items to the system based on a trigger, such as, for example, a schedule, a parameter, an input, a notification, a detected change in metadata, a purchase request, a message, a date, a flag, a lapsed period of time, a timestamp, etc.

Next, the system determines the differences in the hash values associated with the items in the client listing from the client device with the hash values associated with the items in the server listing. The system can determine the differences of the hash values by determining that a portion of a hash value associated with one of the items in the server listing is different than the hash value for the same item in the client listing, and based thereon, further determining that the item is the same, but metadata or version associated with the item is different and needs to be updated. Moreover, the format of the hash value can be modified to expand or limit the scope of differences the system can detect. For example, to allow the system to detect changes to the art of an item, the art of the item can be included in the information used to compute the hash value. Thus, a change in the hash value would indicate a change in the item's art.

The system then sends to the client device metadata identifying items present in the server listing that were not in the client listing. The metadata can identify items that have been added to and/or deleted from the server listing, so the client device can update the purchase history stored at the client device. The metadata can also include changes and/or updates to the metadata associated with the items in the server listing. For example, since the hash values are based, at least in part, on the item's metadata, the hash values change any time the item's metadata is edited or updated. Accordingly, the system can determine that the item's metadata has changed by comparing the item's hash values from the server and client device. If the system detects a change to the metadata, the system can then send the metadata to the client device to update the item's metadata at the client device. Moreover, the metadata can be configured to identify specific information and/or limit the information it identifies. For example, the client device can request which fields or portion of the item's metadata it will receive. Here, if a user does not wish to receive lyrics at the client device, she can set her metadata preferences to exclude lyrics from the metadata sent to the client device.

In some embodiments, the system maintains a collection of incremental metadata changes for a collection of media items, for each media item represented in the collection, storing a media item identifier and a value, wherein the value is an incremental user metadata change for a respective media item. User metadata can include metadata customized by a user, such as media ratings, user comments, item descriptions, metadata edits, item name, user changes, deletions, additions, etc. The user metadata can also include user metadata associated with a user account, such as a play count, a playback position, a play date, and so forth.

Next, the system receives, from a client device, a request for a metadata sync, the request comprising a last metadata version update number indicative of a last metadata sync received by the client device. The request can also include an item ID, which the system can use to identify the last metadata version update, the last metadata sync received by the client device, and/or the user metadata stored at the client device. Moreover, the request can include a hash value associated with user metadata stored at the client device and/or associated with the last metadata version update number. Similarly, the last metadata version update number can include an item ID associated with user metadata stored at the client device and/or a hash value associated with the user metadata stored at the client device.

The hash value can be used to identify user metadata associated with media that was not purchased from an online store and/or media that does not otherwise have an item ID to identify it. The hash value can be based, for example, on a media item and/or metadata associated with the media item. This way, the hash value can uniquely identify the media item and/or metadata such that, if the media item and/or metadata changes, the hash value also changes. Thus, the system can determine that the media item and/or metadata was updated by looking at the hash value associated with the media item and/or metadata.

The system then sends, to the client device, each metadata update associated with a version update number subsequent to the last metadata version update number indicative of the last metadata sync received by the client device. The version update number subsequent to the last metadata version update number can include an item ID and/or a hash value that is based on an item ID, version information, and/or metadata. Similarly, the last metadata version update number can include an item ID and/or a hash value that is based on an item ID, version information, and/or metadata.

In some embodiments, the system maintains a collection of incremental metadata changes for a collection of media items, for each media item represented in the collection, storing a respective media item identifier and a respective value, wherein the respective value is an incremental user metadata change for a respective media item. Next, the system receives, from a first client device, an additional media item identifier and an additional value, wherein the additional value is a user metadata change for the respective media item. Then, the system updates the respective media item identifier and the respective value based on the additional media item identifier and the additional value. The system can also send, to a second client device, the respective media item identifier and the respective value, wherein the respective value updates user metadata associated with the respective media item and stored at the second client device. This way, the second client device can update the user metadata stored at the second client device using the respective media identifier and the respective value.

### BRIEF DESCRIPTION OF THE DRAWINGS

FIG. 1 illustrates and exemplary system for synchronizing purchase history information and metadata with client devices;

FIG. 2 illustrates an exemplary system for synchronizing purchase history information and metadata with client devices based on a purchase request;

FIG. 3 illustrates an example system for synchronizing purchase history information with client devices;

FIG. 4 illustrates an example system for synchronizing user metadata with client devices;

FIG. 5 illustrates an example of a hash format;

FIG. 6 illustrates an exemplary embodiment of a method for synchronizing purchase history information across devices;

FIG. 7 illustrates an exemplary embodiment of a method for synchronizing metadata with a client device; and

FIG. 8 illustrates an exemplary embodiment of a method for updating user metadata for synchronizing across devices.

FIG. 9 illustrates an example system embodiment; and

FIG. 10 illustrates an exemplary network architecture.

### DETAILED DESCRIPTION

Various embodiments of the disclosure are described in detail below. While specific implementations are described, it should be understood that this is done for illustration purposes only. A person skilled in the relevant art will recognize that other components and configurations may be used without parting from the spirit and scope of the disclosure.

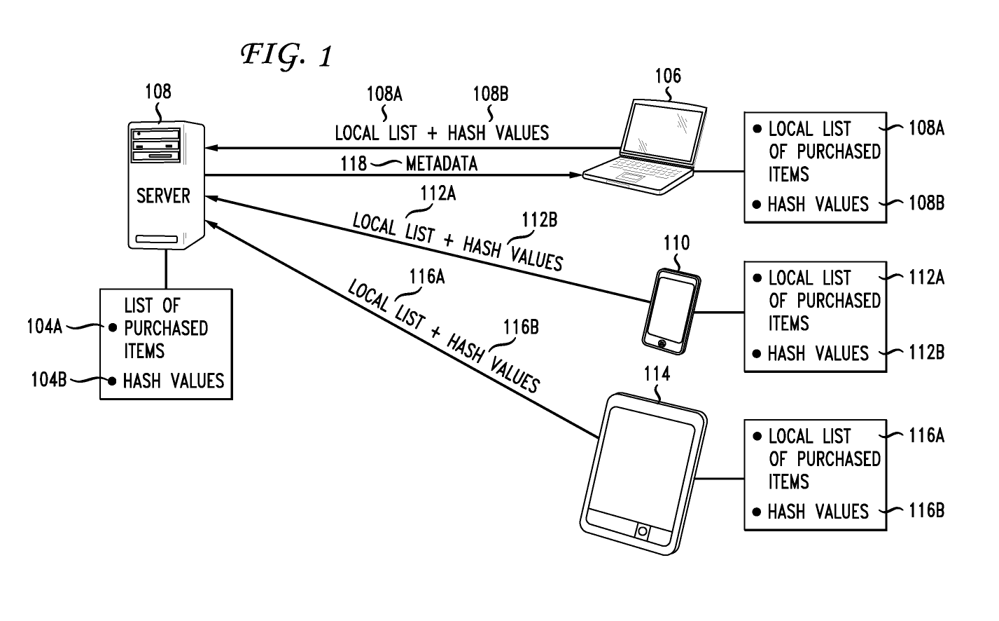

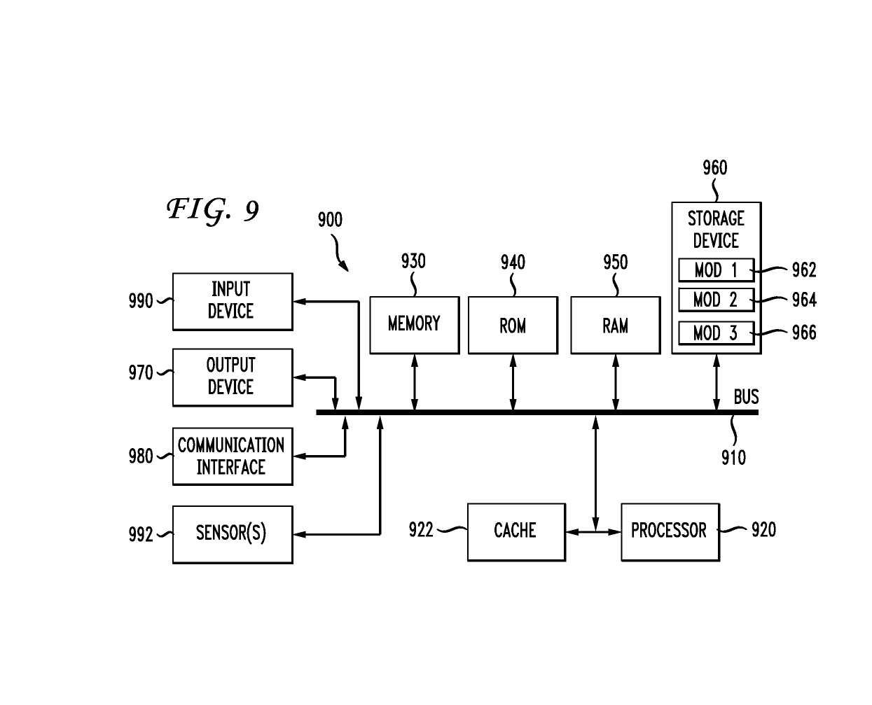

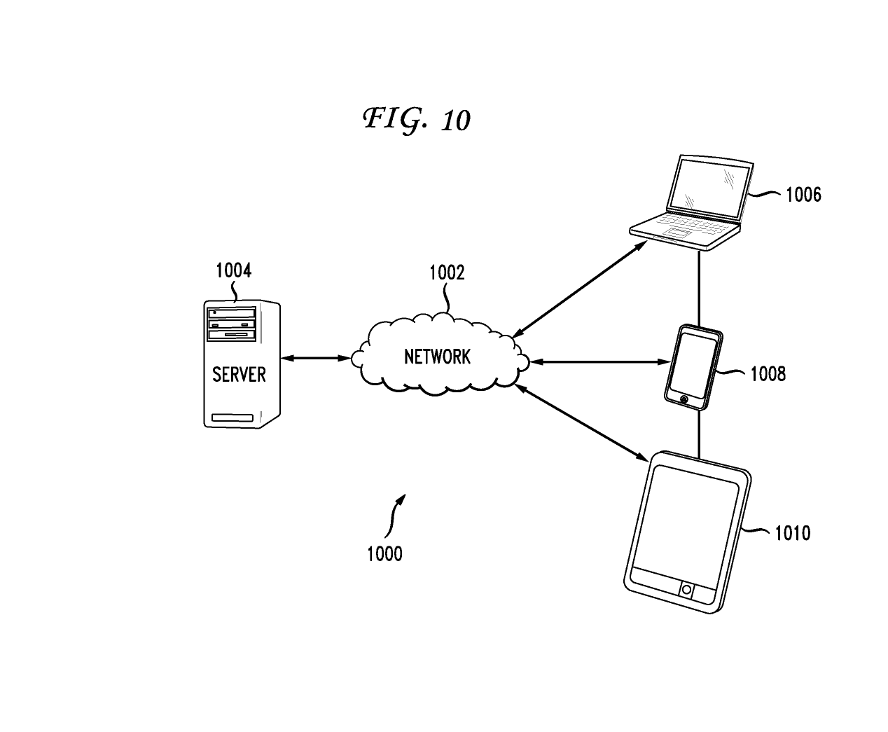

The present disclosure addresses the need in the art for synchronizing purchase history information and user metadata across devices. A system, method and non-transitory computer-readable media are disclosed which synchronize purchase history information and user metadata across devices. A detailed description of synchronizing purchase history information and user metadata, accompanied by variations and examples, is disclosed herein. A brief introductory description of a basic general purpose system or computing device in FIG. 9 and a network architecture in FIG. 10, which can be employed to practice the concepts, will then follow. These variations shall be described herein as the various embodiments are set forth. The disclosure now turns to FIG. 1.

FIG. 1 illustrates and exemplary system for synchronizing purchase history information and metadata with client devices. Here, the client devices 106, 110, 114 maintain a local list of media items 108A, 112A, 116A purchased by a user and hash values 108B, 112B, 116B for the media items on the list. In some embodiments, however, the client devices 106, 110, 114 maintain a local list of media items 108A, 112A, 116A purchased by the user, but do not initially maintain the hash values 108B, 112B, 116B. A hash value refers to a value obtained by applying a hash function or algorithm to a data set to obtain a smaller data set known as the hash value. The local list of media items 108A, 112A, 116A and the hash values 108B, 112B, 116B are associated with a user account of the user. The client devices 106, 110, 114 can also maintain additional information associated with the user account and/or media items, such as, for example, metadata, account details, local media files, customized metadata, etc. The hash values 108B, 112B, 116B can include a hash value for each of the media items on the local list of media items 108A, 112A, 116A. Moreover, the hash values 108B, 112B, 116B can be based on the media items, metadata associated with the media items, and/or an identifier, such as a store ID, associated with the media items.

The local list of media items 108A, 112A, 116A and corresponding hash values 108B, 112B, 116B can differ based on media items purchased, downloaded, and/or removed from each of the client devices 106, 110, 114. For example, the local list of media items 108A, stored at the laptop 106, can include a media item that was recently purchased by a user using the laptop 106 and was not added to the local list of media items 112A and 116A, stored at the client devices 110 and 114, respectively. Accordingly, the local list of media items 108A and hash value 108B will reflect the recent purchase and will thus differ from the local list of media items 112A and 116A and hash values 112B and 116B. As another example, the local list of media items 108A stored at the laptop 106 can include a media item that was recently removed from the local list of media items 112A and 116A, stored at the client devices 110 and 114, respectively. Similarly, the local list of media items 108A will not reflect the recent change and will thus differ from the local list of media items 112A and 116A.

The client devices 106, 110, 114 transmit the local list of media items 108A, 112A, 116A and hash values 108B, 112B, 116B to the server 102. Initially, the client devices 106, 110, 114 can transmit the full local list of media items 108A, 112A, 116A to the server 102. However, the client devices 106, 110, 114 can subsequently limit the information transmitted to the server 102 to only include edits or changes made to the local list of media items 108A, 112A, 116A, and the corresponding hash values 108B, 112B, 116B. The server 102 can then limit the information stored to the edits or changes made to the local list of media items 108A, 112A, 116A, and the corresponding hash values 108B, 112B, 116B.

The server 102 receives the local list of media items 108A, 112A, 116A and hash values 108B, 112B, 116B from the client devices 106, 110, 114, and compares them to the server list of media items 104A purchased by the user and the server hash values 104B, to determine if the client devices 106, 110, 114 have the most current list of purchased media items. In some embodiments, the client devices 106, 110, 114 do not initially maintain the hash values 108B, 112B, 116B and, therefore, do not initially transmit the hash values 108B, 112B, 116B to the server 102. Here, the server 102 receives the local list of media items 108A, 112A, 116A, but not the hash values 108B, 112B, 116B, from the client devices 106, 110, 114. The server 102 can interpret the lack of hash values 108B, 112B, 116B as a mismatch, which could then prompt the server 102 to transmit the hash values 104B to the client devices 106, 110, 114. In other embodiments, the server list of media items 104A is the most current list of purchased media items, and the server 102 continuously updates the server list of media items 104A and server hash values 104B when new media items are purchased or removed by the user. When the user purchases a new media item from the laptop 106, the server 102 can subsequently update the server list of media items 104A and hash values 104B to include the new media item purchased by the user for the user account. Alternatively, when the user purchases a new media item from the laptop 106, the laptop 106 can subsequently transmit to the server 102 metadata indicating the new media item and a corresponding hash value. The server 102 can then use the metadata to update the server list of media items 104A and hash values 104B to include the new media item purchased by the user for the user account. In either case, the server list of media items 104A reflects the most current list of purchased media items. Thus, by comparing the local list of media items 108A, 112A, 116A and hash values 108B, 112B, 116B to the server list of media items 104A and server hash values 104B, the server 102 can determine if the client devices 106, 110, 114 have the most current list of purchased media items.

In some embodiments, the server 102 compares the hash values 108B, 112B, 116B with the server hash values 104B to determine if the client devices 106, 110, 114 have the most current list of purchased media items. Here, the hash values 108B, 112B, 116B can identify the items in the local list of media items 108A, 112A, 116A and/or any changes made thereto, and the server hash values 104B can identify the server list of media items 104 and/or any changes made thereto. Accordingly, by comparing the hash values 108B, 112B, 116B with the server hash values 104B, the server 102 can determine if the client devices 106, 110, 114 have the most current list of purchased media items.

As the server 102 updates the server list of media items 104, the server 102 can include a timestamp on the server list of media items 104 and/or the changes made to the server list of media items 104 to identify the date of the server list of media items 104 and/or the changes made to it. The server 102 can also mark the server list with a version number to identify different versions of the server list of media items 104, based on respective changes and/or content. Likewise, the client devices 106, 110, 114 can mark the local list of media items 108A, 112A, 116A and hash values 108B, 112B, 116B with version numbers and/or timestamps to identify a respective version and/or date of the local list of media items 108A, 112A, 116A and hash values 108B, 112B, 116B.

If the server 102 determines that one or more client devices 106, 110, 114 does not have the most current list of purchased media items, the server 102 can transmit metadata indicating the missing items and hash values to the one or more client devices 106, 110, 114. The one or more client devices 106, 110, 114 can then use the metadata to update the respective local lists of media items 108A, 112A, 116A at the one or more client devices 106, 110, 114. The one or more client devices 106, 110, 114 can also merge items indicated by the metadata as missing with the respective local list of media items 108A, 112A, 116A and a respective list of local non-purchase media, meaning media stored locally that was not purchased by the user from the server 102 or an online store associated with the server 102. For example, the one or more client devices 106, 110, 114 can use the metadata to populate a local playlist with the missing media items from the server media list 304A, the respective local list of media items 108A, 112A, 116A, and a list of local non-purchase media. When populating the local playlist with the missing media items, the one or more client devices 106, 110, 114 can download the missing media items to store them locally.

To provide an example, assume the laptop 106 does not have the current list of purchased media items. Accordingly, the server 102 transmits the metadata 118 to the laptop 306, and the laptop updates the local list of media items 108A and hash values 108B using the metadata 118. The laptop 106 can then access the most current list of media items purchased. If a media item is not stored locally on the laptop 106, the laptop 106 can then stream or download the media item from the server 102 or another computing device. The laptop 106 can identify the missing media item based on the metadata 118 it receives from the server 102. For example, the metadata can include a resource locator address to identify the media item on the server or locally on the device 106. In some embodiments, a bit can be set that indicates that the media item is not stored locally, and therefore must be downloaded or streamed from the server 102. The laptop 106 can then connect to an online store or server that has the missing media item available, and stream or download the missing media item from the online store or server. Media items that are not available on the local device can be visually identified with an icon, such as a cloud or download arrow.

As previously indicated, the metadata 118 includes the missing items and hash values. However, the metadata 118 can also include media metadata such as a song title, a store ID, an album name, a track number, an album art, a timestamp, a release date, lyrics, etc.; and user metadata, such as a play count, a play position, a play date, a rating, a user comment, and any other customized metadata. Moreover, the server 102 can transmit the metadata 118 to the one or more client devices 106, 110, 114 automatically after an update/change, or based on a trigger, such as a request, a message, a schedule, a parameter, a time, a history, an input, an update history, a polling response, an event, a lapse of time, a flag, a notification, etc.

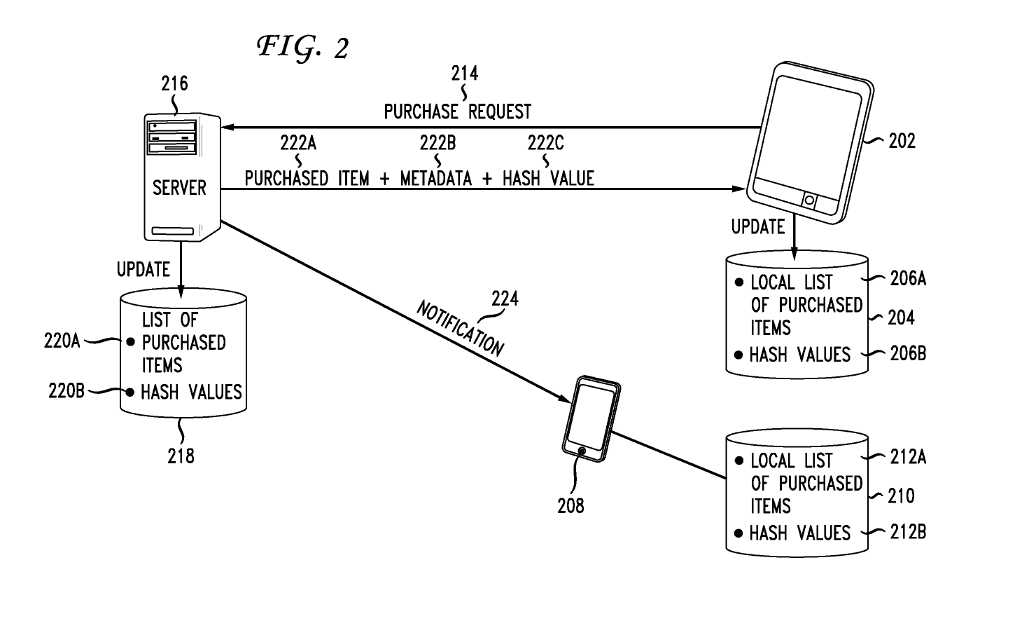

FIG. 2 illustrates an exemplary system for synchronizing purchase history information and metadata with client devices based on a purchase request. The portable media player 202 stores a local list of media items 206A purchased by a user and hash values 206B associated with the media items, at a local storage 204 on the portable media player 202. Similarly, the mobile phone 208 stores a local list of media items 206A purchased by the user and hash values 212B associated with the media items, at a local storage 410 on the mobile phone 208. The portable media player 202 can receive input from the user requesting to purchase a media item from the server 216, which can be an online store, for example. The portable media player 202 then sends a purchase request 214 to the server 216. The purchase request includes information identifying the media item to be purchased and the user account associated with the user initiating the purchase request 214.

After receiving the purchase request 214, the server 216 transmits the purchased media item 222A, metadata 222B associated with the purchased media item 222A, and a hash value 222C associated with the purchased media item 222A to the portable media player 202. The server 216 also updates the server list of media items 220A and server hash values 220B, which represent the current list of media items purchased for the user's account. The server list of media items 220A and server hash values 220B can be stored on a local storage 218 on the server 216 and/or a remote device. The metadata 222B can include media metadata, such as media art, track title, track duration, album title, store ID, lyrics, album date, purchase date, etc. The metadata 222B can also include user metadata, such as a play count, a play date, a rating, and customized metadata. Moreover, the hash value 222C can be based on the purchased item 222A and/or the metadata 222B.

After receiving the purchase request 214, the server 216 also transmits a notification 224 to the mobile phone 208, indicating that the server list of media items 220A has changed. The notification 224 can include the purchased media item 222A, metadata 222B, and hash value 222C, which the mobile phone 208 can use to update the local list of media items 206A and hash values 212B. By updating the local list of media items 206A and hash values 212B, the mobile phone 208 can ensure that it maintains the most current list of purchased media items.

When the portable media player 202 receives the purchased media item 222A, metadata 222B, and hash value 222C from the server 216, it updates the local list of media items 206A and hash values 206B to ensure that it maintains the most current list of purchased media items. Having the most current list of purchased media items at both the portable media player 202 and mobile phone 208 allows the user to maintain a synchronized purchase history across devices and access all the purchased media from any device.

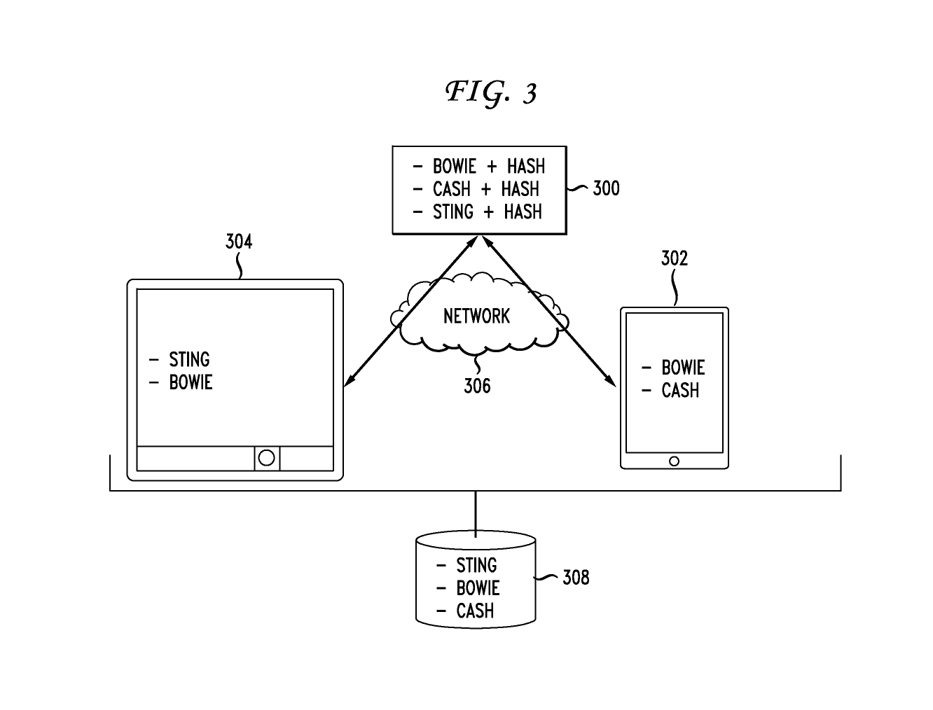

FIG. 3 illustrates an exemplary system for synchronizing purchase history information with client devices. The mobile phone 302 and portable media player 304 each have a list of purchased media items. As illustrated in FIG. 3, the list of purchased media items in mobile phone 302 includes a song by David Bowie and a song by Johnny Cash, and the list of purchased media items in portable media player 304 includes a song by Sting and the song by David Bowie. The cloud 300 stores a server list of media items stored at the mobile phone 302 and portable media player 304. In this example, the server list of media items in the cloud 300 includes the purchased songs by David Bowie, Johnny Cash, and Sting. The cloud 300 also stores a hash for each of the purchased songs in the server list.

The hash can be a hash value based on the media item, an item ID, a version number, an account ID, metadata associated with the media item, a media ID, user metadata, etc. The hash value can identify a corresponding media item, to allow the cloud 300 determine which media items are missing from the mobile phone 302 and/or the portable media player 304 by comparing hash values. Thus, the cloud 300 can compare the hash values stored in the cloud 300 with those stored at the mobile phone 302 and portable media player 304, to determine if the mobile phone 302 and portable media player 304 have a complete and current list of media items associated with the user account. The cloud 300 can then transmit any missing media items to the mobile phone 302 and portable media player 304 via the network 306. The mobile phone 302 and portable media player 304 can then update their respective lists of local media items based on the missing media items received from the cloud 300, to generate an updated list of local media items 308 at each client device 302, 304.

The cloud 300 can include a server, a computing device, a database, a cluster, an online store, and/or any remote network resource. The network 306 can include a public network, such as the Internet, but can also include a private or quasi-private network, such as an intranet, a home network, a virtual private network (VPN), a shared collaboration network between separate entities, etc. Indeed, as one of ordinary skill in the art will readily recognize, the principles set forth herein can be applied to local area networks, wide area networks, virtual private networks, intranets, home networks, corporate networks, and virtually any other form of network, as well as multiple interconnected networks. While the client devices 302, 304 in FIG. 3 are a mobile phone and a portable media player, the client devices in other embodiments can include virtually any device with media and networking capabilities, such as computers, mobile phones, video game consoles, portable media players, IP televisions, etc.

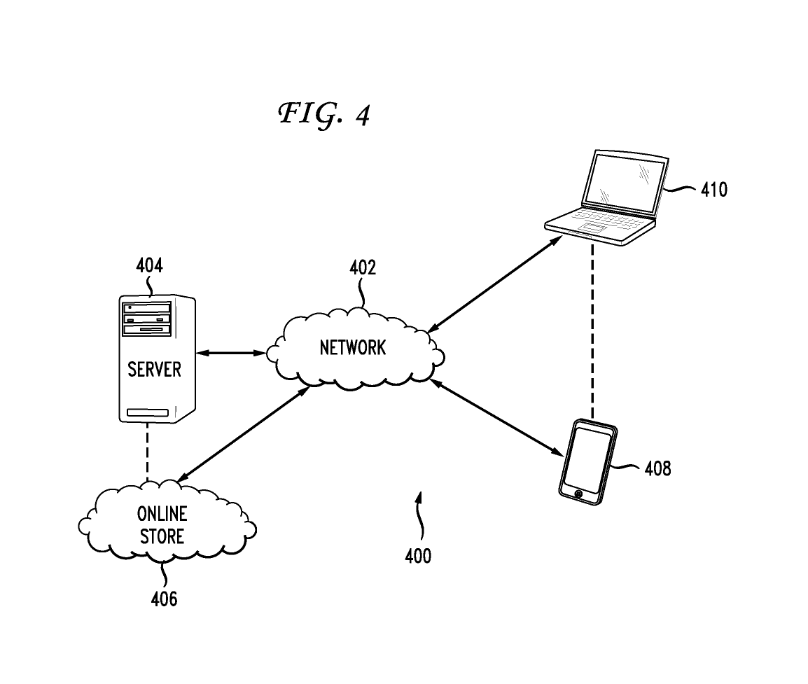

FIG. 4 illustrates an exemplary system 400 for synchronizing user metadata across devices. A user can access media files from the client devices 408, 410. The client devices 408, 410 can store media, such as audio and video files, purchased from the online store 406, received from a remote location, and/or local non-purchase media stored on the client devices 408, 410. The client devices 408, 410 are associated with the same user account. Accordingly, both client devices 408, 410 can access the online store 406 for the user account, and any files purchased from the online store 406 for the user account. The client devices 408, 410 can synchronize information, such as media and metadata, with each other via USB, Firewire, Thunderbolt, 802.11 series, and/or Bluetooth wireless connections. The client devices 408, 410 can also synchronize information with the side server 404 and/or the online store 406 via the network 402. The network 402 can include a public network, such as the Internet, but can also include a private or quasi-private network, such as an intranet, a home network, a virtual private network (VPN), a shared collaboration network between separate entities, etc. Indeed, as one of ordinary skill in the art will readily recognize, the principles set forth herein can be applied to local area networks, wide area networks, virtual private networks, intranets, home networks, corporate networks, and virtually any other form of network, as well as multiple interconnected networks.

Moreover, the client devices 408, 410 can communicate with the side server 404, via the network 402, to receive user metadata associated with the user account and any user metadata updates. In some embodiments, the side server 404 can be part of the online store, while in some embodiments, the side server 404 is a separate server for managing metadata sync. The client devices 408, 410 can also purchase, download, and/or stream media from the online store 406 via the network 402. The online store 406 can store a collection of media which the client devices 408, 410 have purchased and/or media which the client devices 408, 410 can purchase. Each media item in the online store 406 can have an item ID and store metadata associated with it. The client devices 408, 410 can similarly store an item ID and store metadata for media items purchased from the online store 406. The online store 406 and client devices 408, 410 can also store user metadata. User metadata can include metadata customized by a user with access to the user account through the client devices 408, 410, such as media ratings, user comments, item descriptions, metadata edits, item name, user changes, deletions, additions, etc. The user metadata can also include user metadata associated with a user account, such as play count, playback position, play date, and so forth.

The user metadata stored at the online store 406 and client devices 408, 410 can be the same. However, the user can modify the user metadata stored at the client device 408 and/or 410. As a result, the modified user metadata will be different than the user metadata stored at the online store 406 and/or client device 408 and/or 410. For example, a song titled “Madonna” is currently stored at the online store 406 and the client devices 408, 410. The user modifies the title of the song stored at the client device 408 to “madonna.” Here the user metadata associated with the song (the name of the song in this case) at the client device 408 will differ from the user metadata associated with the same song stored at the online store 406 and client device 410.

Moreover, the user metadata can also be modified by a program on the client devices 408, 410. For example, media players, such as Apple's iTunes player, add user metadata to media, such as play and skip counts, that the media players use to make/edit playlists, provide suggestions, and/or generate a customized media experience for the user. However, the user metadata added by the media players to media from one of the client devices 408, 410 is not stored at the online store 406 or the other client device from the client devices 408, 410. Accordingly, the user metadata stored at the online store 406 and client devices 408, 410 will differ.

When user metadata is edited/updated, the system 400 can synchronize the changes with the client devices 408, 410, so the user has access to the current version of the user metadata from both of the client devices 408, 410. The side server 404 can store changes made to the user metadata, which can then be synchronized with the client devices 408, 410. The side server 404 does not have to store the entire media file, but rather information identifying the user metadata and a value associated with the user metadata changes. For items purchased from the online store 406, the side server 404 can store an item ID associated with each song purchased by the user from the online store 406. For items that are stored locally on the client devices 408, 410 and were not purchased from the online store 406, such as local non-purchase media, the side server 404 can compare metadata for the non-purchase media with metadata for items in the online store in attempt to identify the non-purchase media. In some embodiments, an audio-fingerprint or digital fingerprint can be sampled from the actual media item on the client device, and a service, such as Gracenote® can identify the identity of the media item. If a version of the media item exists in the online store, the side server can record the online store identifier for that media item.

When one of the client devices 408, 410 modifies/updates user metadata, it can transmit the updates to the side server 404. This can be done as a batch of updates or a single update. When transmitting updates to the side server 404, the client devices 408, 410 can transmit the item ID along with the metadata value that has changed. For example, client device 408 can transmit the item ID associated with the song titled “madonna” and the value “madonna,” which was the modified title of the song that was modified by the user in our previous example. The side server 404 uses the item ID to identify the metadata, and records the metadata change value for that item ID. The side server 404 can also give the metadata update a version number to identify an update version of the metadata. If the media is not a purchased media file, the side server 404 can use the hash value of the metadata associated with the media file to identify the metadata. Here, the side server 404 records the metadata change value for the metadata associated with that hash value.

When the client devices 408, 410 communicate with the side server 404, they can send their last metadata update version number to the side server 404. The side server 404 can compare the last metadata update version number received from the client devices 408, 410 with the version number stored at the side server 404 to determine if the client devices 408, 410 have the most current version of the metadata. If the side server 404 determines that any of the client devices 408, 410 do not have the latest metadata updates, it can transmit the latest metadata updates to the appropriate client devices 408, 410, which the client device can use to update the metadata stored at the client device.

The side server 404 can record every change to the user metadata. Thus, the client devices 408, 410 can communicate with the side server 404 to obtain the most recent changes to the user metadata. The most recent user metadata can then be represented at each of the client devices 408, 410. As the side server 404 receives changes, it can overwrite previous changes made to the same field of the metadata. This way, the side server 404 can maintain the most current of multiple updates made. For scalability purposes, the side server 404 can limit the history of changes maintained according to a specific parameter or date. In one embodiment, the side server 404 only keeps a history going back to thirty days to avoid the stored metadata from getting too large. In this embodiment, as long as the client devices 408, 410 update their user metadata once every thirty days, they will have the most current user metadata.

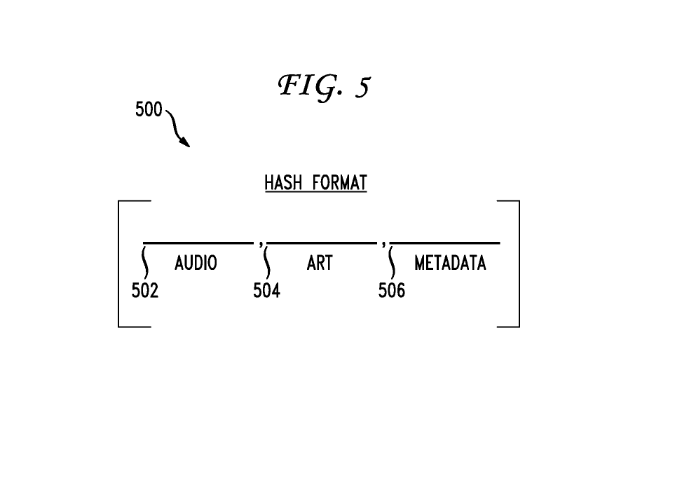

FIG. 5 illustrates an example of a hash format 500. As illustrated, the hash format 500 includes an audio hash value 502, an art hash value 504, and a metadata hash value 506. In this example, the audio hash value 502 is based on an audio file, the art hash value 504 is based on the artwork of the audio file, and the metadata hash value 506 is based on the metadata associated with the audio file. The hash format 500 can indicate changes made to the audio file, the artwork, and the metadata associated with the audio file, as the hash values are based on these components, and would therefore change when these components change. In other aspects, the hash format 500 only includes the audio hash value 502 and the metadata hash value 506. In yet other aspects, the hash format 500 includes additional hash value, such as, for example, a store ID hash value, an account ID hash value, a user metadata hash value, a name hash value, a secondary ID hash value, etc.

While the illustrated hash format 500 is based on an audio file, the principles disclosed herein can also be applied in the context of other media, such as video, image, text, and so forth. Moreover, the hash format 500 can include more or less fields than those illustrated in FIG. 5. However, for simplicity, the hash format 500 in FIG. 5 is illustrated as having three fields for hash values.

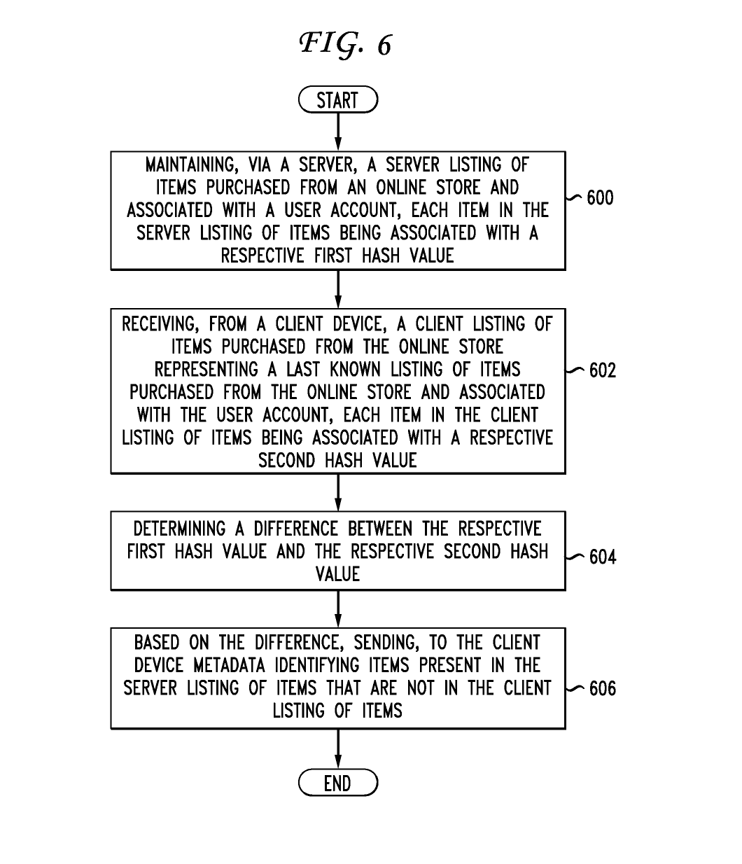

Having disclosed some basic system components and concepts, the disclosure now turns to the exemplary method embodiments shown in FIGS. 6-8. For the sake of clarity, the methods are described in terms of an exemplary system 900, as shown in FIG. 9, configured to practice the methods. The steps outlined herein are exemplary and can be implemented in any combination thereof, including combinations that exclude, add, or modify certain steps.

FIG. 6 illustrates an exemplary embodiment of a method for synchronizing purchase history information across devices. The system 900 maintains a server listing of items purchased from an online store and associated with a user account, each item in the server listing of items being associated with a hash value (600). The server listing of items can be a full list of media items purchased from the online store using the user account. The list of media items can be purchased from the online store via one or more client devices that are associated with the user account. The server listing of items can also include metadata associated with the items. For example, the server listing of items can include lyrics, album art, song title, duration, store ID, account ID, and other metadata associated with the items.

The system 900 then receives, from a first client device, a client listing of items purchased from the online store representing the last known listing of items purchased from the online store and associated with the user account, each item in the client listing of items being associated with a hash value (602). The client listing of items is maintained by the first client device. Other devices can also maintain separate listings of items, which can be potentially the same as, or different from, the client listing of items maintained by the first client device. The hash value can be based on the item ID, version information, store ID associated with the item, metadata associated with the item, fingerprint associated with the item, name of the item, etc. For example, if an item is an audio file, the hash value can be based on the audio file, the store ID for the audio file, and/or the metadata associated with the audio file. Moreover, the first client device can be configured to send the client listing of items to the system 900 based on a trigger, such as, for example, a schedule, a parameter, an input, a notification, a detected change in metadata, a purchase request, a message, a date, a flag, a lapsed period of time, a timestamp, etc.

Next, the system 900 determines the differences in the hash values associated with the items in the client listing from the first client device with the hash values associated with the items in the server listing (604). The system 900 can determine the differences of the hash values by determining that a portion of a hash value associated with one of the items in the server listing is different than the hash value for the same item in the client listing, and based thereon, further determining that the item is the same, but metadata or version associated with the item is different and needs to be updated. Moreover, the format of the hash value can be modified to expand or limit the scope of differences the system 900 can detect. For example, to allow the system 900 to detect changes to the art of an item, the art of the item can be included in the information used to compute the hash value. Thus, a change in the hash value would indicate a change in the item's art. As another example, the format of the hash value can include a portion for the audio of an item, another portion for the art, and another portion for the metadata. Here, a change in the hash value would indicate a change in the item's content (e.g., audio, video, text, images), art, and/or metadata, depending on the portion of the hash value that has changed.

Finally, the system 900 sends to the client device metadata identifying items present in the server listing that were not in the client listing (606). The metadata can identify items that have been added to and/or deleted from the server listing, in order to update the purchase history stored at the client device. The metadata can also include changes and/or updates to the metadata associated with the items in the server listing. For example, since the hash values are based, at least in part, on the item's metadata, the hash values change any time the item's metadata is edited or updated. Accordingly, the system 900 can determine that the item's metadata has changed by comparing the item's hash values from the server and client device. If the system 900 detects a change to the metadata, the system 900 can then send the metadata to the client device to update the item's metadata at the client device. Moreover, the metadata can be configured to identify specific information and/or limit the information it identifies. For example, the client device can request which fields or portion of the item's metadata it will receive. Here, if a user does not wish to receive lyrics at the client device, she can set her metadata preferences to exclude lyrics from the metadata sent to the client device.

In some embodiments, the system 900 receives, from the client device, a request to purchase a particular item, and subsequently updates the server listing to reflect the purchase of the particular item, which includes a hash value specific to that version of the particular item. The system 900 then sends the particular item to the first client device along with metadata identifying the item and the hash value specific to that version of the particular item. In another embodiment, the system 900 receives, from a second client device, a client listing of items purchased from the online store representing the last known listing of items purchased from the online store and associated with the user account, each item in the listing of items being associated with a hash value. The system 900 then determines the differences in the hash values associated with the items in the client listing on the second client device with the hash values associated with the items in the server listing, and sends, to the second client device, metadata identifying items present in the server listing that were not in the client listing from the second client device.

The system 900 can also be configured with a deduplication mechanism according to various rules. For example, if the metadata associated with an item at the server matches with the metadata associated with an item at the client device, then the two items are likely to be the same. However, in certain cases, two items can have the same name, artist, ID, etc., even though the two items are different. For example, a file generically titled “Track 01” may not be the same as another file titled “Track 01.” Thus, various rules can be implemented to avoid duplicating items and/or incorrectly ignoring different items with the same or similar metadata. The rules in the deduplication mechanism can be based on the characteristics of the item and/or metadata associated with the item. For example, the album name, song name, artist name, duration, etc., of the items can be compared to determine if the items are the same.

The rules can specify a threshold which, when reached, indicates that the items are different. In one embodiment, items are considered different if their respective durations vary by over 10%. The rules can also specify a black list of metadata, which identifies metadata that the system 900 should ignore. For instance, a generic audio title, such as “Track 01,” can be included in the black list such that audio files titled “Track 01” are not deemed to be the same simply because they share the generic, blacklisted term “Track 01.” The rules can also include various criteria for determining if two items are the same. In one embodiment, the rules specify three criteria which must be met, individually or in combination, when determining that two tracks are the same. First, two tracks are determined to be the same if they have the same store ID or item ID. Second, two tracks are determined to be the same if they have the same secondary ID, which is an identifier of items that remains the same when items are removed from the store and reimported, and is shared by the item across countries. Third, two tracks are determined to be the same if they have the same metadata, including metadata that is not trivial or otherwise in a black list. For example, the difference between “Lion King” and “The Lion King” would be deemed trivial for purposes of determining if the two items are the same. The criteria in the rules can be analyzed to compute a similarity score. If the similarity score reaches a threshold, then the two items are determined to be the same. In addition, the criteria in the rules can be analyzed to compute a score representing a difference. Then, if the score reaches a threshold, then the two items are determined to be different.

Different criteria from the rules can be applied to different items. For example, if two items were purchased from the online store, they will likely have a store ID that can be used to compare the items and determine if they are the same. However, if the items are local items, such as local non-purchase media, then the items may not have a store ID that can be used to compare the items. Here, the similarity score of the items can be determined based on the metadata. Further, if the items were removed from the online store and reimported into the online store, they may have different online IDs even if they are the same. In this case, the items can be compared based on the secondary ID, which remains the same even when the items are reimported into the online store. Thus, different approaches can be used when processing media available at an online store, media reimported into an online store, and local non-purchase media.

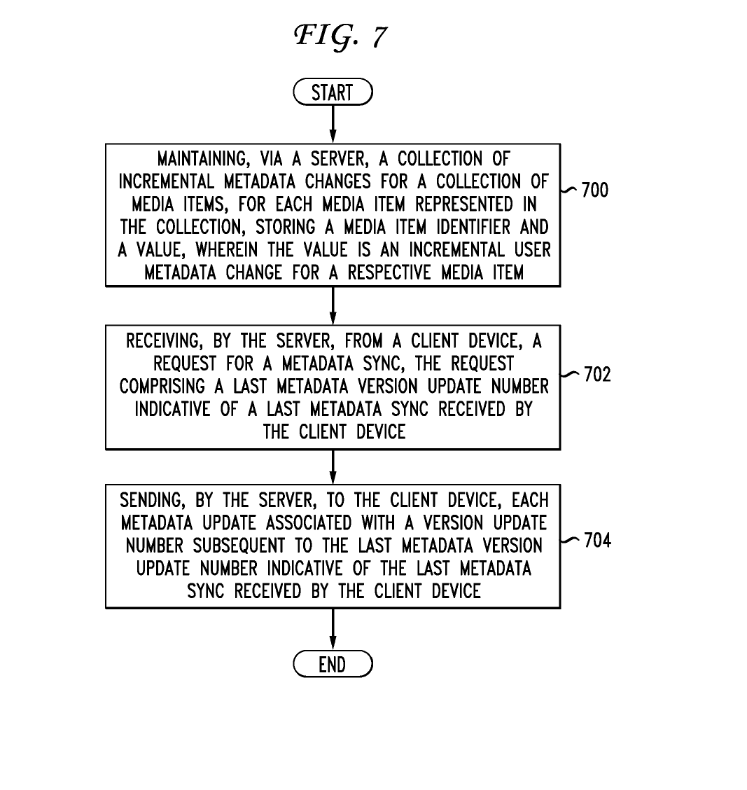

FIG. 7 illustrates an exemplary embodiment of a method for synchronizing metadata with a client device. As illustrated, the system 900 maintains a collection of incremental metadata changes for a collection of media items, for each media item represented in the collection, storing a media item identifier and a value, wherein the value is an incremental user metadata change for a respective media item (700). User metadata can include metadata customized by a user, such as media ratings, user comments, item descriptions, metadata edits, item name, user changes, deletions, additions, etc. The user metadata can also include user metadata associated with a user account, such as a play count, a playback position, a play date, and so forth.

Next, the system 900 receives, from a client device, a request for a metadata sync, the request comprising a last metadata version update number indicative of a last metadata sync received by the client device (702). The request can also include an item ID, which the system 900 can use to identify the last metadata version update, the last metadata sync received by the client device, and/or the user metadata stored at the client device. Moreover, the request can include a hash value associated with user metadata stored at the client device and/or associated with the last metadata version update number. Similarly, the last metadata version update number can include an item ID associated with user metadata stored at the client device and a hash value associated with the user metadata stored at the client device.

The hash value can be used to identify user metadata associated with media that was not purchased from an online store and/or media that does not otherwise have an item ID to identify it. The hash value can be based, for example, on a media item and/or metadata associated with the media item. This way, the hash value can uniquely identify the media item and/or metadata such that, if the media item and/or metadata changes, the hash value also changes. Thus, the system 900 can determine that the media item and/or metadata was updated, by looking at the hash value associated with the media item and/or metadata. For example, if a user changes a song title from “Madonna” to “madonna” (lower case), the system 900 can determine that the user changed the title of the song by looking at the hash value associated with the song.

In some embodiments, the last metadata sync received by the client device is associated with a timestamp, and the system 900 uses the timestamp to determine if the client device has a most recent incremental user metadata change. The system 900 can do this by comparing the timestamp associated with the last metadata sync with the timestamp associated with the most recent incremental user metadata change stored at the system 900. In other embodiments, the system 900 determines if the client device has the most recent incremental user metadata change by comparing the last metadata version update number with the metadata version update number associated with the most recent incremental user metadata change stored at the system 900. In yet other embodiments, the system 900 determines if the client device has the most recent incremental user metadata change by comparing a hash value associated with the last metadata sync received by the client device with a hash value associated with the most recent incremental user metadata change stored at the system 900. In additional embodiments, the system 900 determines if the client device has the most recent incremental user metadata change by implementing a combination of the procedures discussed herein.

The system 900 then sends, to the client device, each metadata update associated with a version update number subsequent to the last metadata version update number indicative of the last metadata sync received by the client device (704). The version update number subsequent to the last metadata version update number can include an item ID and/or a hash value that is based on an item ID, version information, and/or metadata. Similarly, the last metadata version update number can include an item ID and/or a hash value that is based on an item ID, version information, and/or metadata.

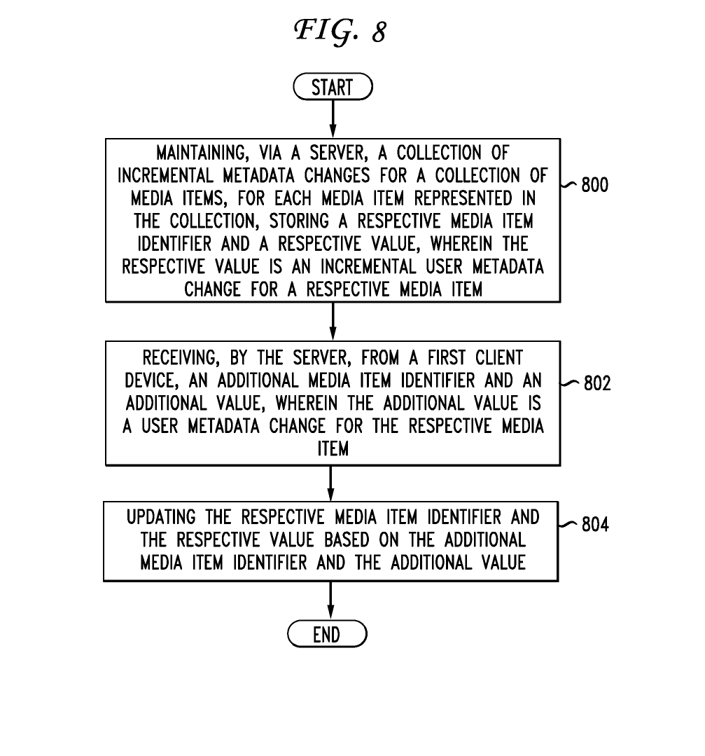

FIG. 8 illustrates an exemplary embodiment of a method for synchronizing user metadata across devices. The system 900 maintains a collection of incremental metadata changes for a collection of media items, for each media item represented in the collection, storing a respective media item identifier and a respective value, wherein the respective value is an incremental user metadata change for a respective media item (800). Next, the system 900 receives, from a first client device, an additional media item identifier and an additional value, wherein the additional value is a user metadata change for the respective media item (802). Then, the system 900 updates the respective media item identifier and the respective value based on the additional media item identifier and the additional value (804). In one embodiment, the system 900 sends, to a second client device, the respective media item identifier and the respective value, wherein the respective value updates user metadata associated with the respective media item and stored at the second client device. Here, the second client device can then update the user metadata stored at the second client device using the respective media identifier and the respective value.

With reference to FIG. 9, an exemplary system includes a general-purpose computing device 900, including a processing unit (CPU or processor) 920 and a system bus 910 that couples various system components including the system memory 930 such as read only memory (ROM) 940 and random access memory (RAM) 950 to the processor 920. The computing device 900 can include a cache 922 of high speed memory connected directly with, in close proximity to, or integrated as part of the processor 920. The system 900 copies data from the memory 930 and/or the storage device 960 to the cache 922 for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a non-transitory computer-readable medium in connection with the necessary hardware components, such as the processor 920, bus 910, display 970, and so forth, to carry out the function. The basic components are known to those of skill in the art and appropriate variations are contemplated depending on the type of device, such as whether the computing device 900 is a small, handheld computing device, a desktop computer, or a computer server.

Although the exemplary embodiment described herein employs the hard disk 960, it should be appreciated by those skilled in the art that other types of computer-readable media which can store data that are accessible by a computer, such as magnetic cassettes, flash memory cards, digital versatile disks, cartridges, random access memories (RAMs) 950, read only memory (ROM) 940, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 920. The functions these blocks represent may be provided through the use of either shared or dedicated hardware, including, but not limited to, hardware capable of executing software and hardware, such as a processor 920, that is purpose-built to operate as an equivalent to software executing on a general purpose processor. For example the functions of one or more processors presented in FIG. 9 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 940 for storing software performing the operations described below, and random access memory (RAM) 950 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The computing device 900 shown in FIG. 9 can practice all or part of the recited methods, can be a part of the recited systems, and/or can operate according to instructions in the recited non-transitory computer-readable storage media. Such logical operations can be implemented as modules configured to control the processor 920 to perform particular functions according to the programming of the module. For example,

FIG. 9 illustrates three modules Mod1 962, Mod2 964 and Mod3 966 which are modules configured to control the processor 920. These modules may be stored on the storage device 960 and loaded into RAM 950 or memory 930 at runtime or may be stored as would be known in the art in other computer-readable memory locations.

Having disclosed some components of a computing system, the disclosure now turns to FIG. 10, which illustrates an exemplary network architecture 1000. The network architecture 1000 includes a server 1004, which transmits metadata and purchase history information to the client devices 1006, 1008, 1010. The server 1004 communicates with the client devices 1006, 1008, 1010 via the network 1002. The network 1002 can include a public network, such as the Internet, but can also include a private or quasi-private network, such as an intranet, a home network, a virtual private network (VPN), a shared collaboration network between separate entities, etc. Indeed, as one of ordinary skill in the art will readily recognize, the principles set forth herein can be applied to local area networks, wide area networks, virtual private networks, intranets, home networks, corporate networks, and virtually any other form of network, as well as multiple interconnected networks.

The client devices 1006, 1008, 1010 can include virtually any device with media and networking capabilities, such as computers, mobile phones, video game consoles, portable media players, IP televisions, etc. In FIG. 10, the client device 1006 is a laptop computer, client device 1008 is a mobile phone, and client device 1010 is a portable media player. The client devices 1006, 1008, 1010 can be associated with a user via, for example, a user account accessed from the client devices 1006, 1008, 1010. To this end, the client devices 1006, 1008, 1010 can store media, playlists, metadata, purchase libraries, settings, details, preferences, and/or other information associated with the user account. The client devices 1006, 1008, 1010 can synchronize information, such as media and metadata, with each other via USB, Firewire, Thunderbolt, 802.11 series, and/or Bluetooth wireless connections. The client devices 1006, 1008, 1010 can also synchronize information, such as purchased items and metadata changes, with the server 1004 via the network 1002.

The server 1004 can be any computing device with networking capabilities. The server 1004 can transmit, to the client devices 1006, 1008, 1010, information associated with a user account, such as, for example, media files, a list of purchased items, a list of purchased item updates, metadata, metadata updates, playlists, playlist changes, purchase history information, account details, and/or notifications. In one embodiment, the server 1004 transmits to the client devices 1006, 1008, 1010 a list of media items purchased by a user and metadata associated with the media items. The list of media items purchased by a user can be a full list of purchased items, or the difference between the list of purchased items stored at the server 1004 and a list of purchased items stored at the client devices 1006, 1008, 1010.

In another embodiment, the server 1004 transmits to the client devices 1006, 1008, 1010 user metadata updates. The user metadata updates can include the full portion of the updated user metadata, or the edited portion of the user metadata stored at the client devices 1006, 1008, 1010. The server 1004 can obtain the user metadata updates from one of the client devices 1006, 1008, 1010, and transmit the user metadata updates to any other device from the client devices 1006, 1008, 1010.

The information associated with a user account, transmitted by the server 1004 to the client devices 1006, 1008, 1010, can be stored on the server 1004 and/or a remote computing device or database. For example, the information associated with a user account can be stored on a remote computing device, which transmits the information to the client devices 1006, 1008, 1010 in response to a request from the server 1004. Alternatively, the remote computing device can transmit the information to the server 1004, which relays the information to the client devices 1006, 1008, 1010. Moreover, the server 1004 can store a list of purchased items and metadata associated with the purchased items. For example, the server 1004 can store a list of media purchased for a user account, and any metadata, such as artwork and titles, associated with the purchased media. The server 1004 can also store edits made to user metadata, such as ratings, play count, play date, and customized metadata. The server 1004 can store the metadata edits as a key and a value to minimize the amount of storage necessary. The key can be a store ID or a hash value, for example, used to identify the metadata edits. The value in the metadata edits can identify the actual edits made to the metadata, such as a rating added to a song, for example.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as described above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
maintaining, via a server, a server listing of items purchased from an online store and associated with a user account, each item in the server listing of items being associated with a respective first hash value;
receiving, from a client device, a client listing of items purchased from the online store representing a last known listing of items purchased from the online store and associated with the user account, each item in the client listing of items being associated with a respective second hash value;
determining a difference between the respective first hash value and the respective second hash value; and
based on the difference, sending, to the client device, metadata identifying items present in the server listing of items that are not in the client listing of items.

2. The method of claim 1, further comprising:
receiving, from the client device, a request to purchase a particular item;
updating the server listing of items to reflect the purchase of the particular item and a hash value specific to a version of the particular item; and
sending the particular item to the client device along with metadata identifying the particular item and the hash value.

3. The method of claim 1, the method further comprising:
receiving, from a different client device, an additional client listing of items purchased from the online store representing the last known listing of items purchased from the online store and associated with the user account, each item in the listing of items being associated with a respective third hash value;
determining a difference between the respective first hash value and the respective third hash value; and
sending, to the different client device, metadata identifying items present in the server listing of items that are not in the additional client listing of items.

4. The method of claim 3, further comprising updating the server listing of items based on an item in at least one of the client listing of items and the additional client listing of items, wherein the item is not in the server listing of items.

5. The method of claim 1, wherein the respective first hash value and the respective second hash value are based on at least one of an item ID, version information, and metadata.

6. The method of claim 5, wherein determining the difference between the respective first hash value and the respective second hash value further comprises:
determining that a portion of the respective second hash value associated with an item is different than a hash value for a corresponding item in the client listing of items to yield a determination; and
based on the determination, determining that the item and the corresponding item are a same item, but at least one of metadata and a version associated with the corresponding item is different and needs to be updated.

7. The method of claim 1, wherein at least one of the server listing of items, the respective first hash value, the client listing of items, and the respective second hash value is associated with a timestamp.

8. The method of claim 1, wherein the respective first hash value and the respective second hash value are based on a hash format comprising a media hash value and a metadata hash value.

9. The method of claim 1, further comprising:
receiving by the server, a download request from the client device, the download request includes a portion of the metadata;
utilizing the metadata to identify the media item in the online store and to verify the client device's entitlement to the media item; and
sending the media item from to the client device.

10. The method of claim 1, further comprising:
receiving a request to purchase a media item, wherein the request is associated with the user account;
notifying the client device that the server listing of items has a new item; and
sending, to the client device, metadata identifying the media item as the new item.

11. A system comprising:
a processor; and
a computer-readable storage medium having stored thereon instructions which, when executed by the processor, cause the processor to perform a method comprising:
maintaining, via a server, a listing of items purchased from an online store and associated with a user account, each item in the listing of items having a respective first hash value;
receiving from a client device, a client listing of items purchased from the online store representing a last known listing of items purchased from the online store and associated with the user account, each item in the client listing of items having a respective second hash value;
determining a difference between the client listing of items and the listing of items; and
based on the difference, sending, to the client device, metadata identifying items present in the listing of items that are not in the client listing of items.

12. The system of claim 11, wherein the computer-readable storage medium stores additional instructions which result in the method further comprising:
receiving, from the client device, a request to purchase a particular item;
updating the listing of items to reflect the purchase of the particular item and a hash value specific to a version of the particular item; and
sending the particular item to the client device along with metadata identifying the particular item and the hash value.

13. The system of claim 11, wherein the computer-readable storage medium stores additional instructions which result in the method further comprising:
receiving, from a different client device, an additional client listing of items purchased from the online store representing the last known listing of items purchased from the online store and associated with the user account, each item in the listing of items being associated with a respective third hash value;
determining an additional difference between the respective first hash value and the respective third hash value; and
sending, to the different client device, metadata identifying items present in the listing of items that are not in the additional client listing of items.

14. The system of claim 13, further comprising updating the server listing of items based on an item in at least one of the client listing of items and the additional client listing of items, wherein the item is not in the server listing of items.

15. The system of claim 11, wherein the respective first hash value and the respective second hash value are based on at least one of an item ID, version information, and metadata.

16. A non-transitory computer-readable storage medium having stored therein instructions which, when executed by a processor, cause the processor to perform a method comprising:
maintaining, via a server, a server listing of items purchased from an online store and associated with a user account, each item in the server listing of items being associated with a respective first hash value;
receiving a client listing of items purchased from the online store representing a last known listing of items purchased from the online store and associated with the user account, each item in the client listing of items being associated with a respective second hash value;
determining a difference between the respective first hash value and the respective second hash value; and
based on the difference, sending metadata identifying items present in the server listing of items that are not in the client listing of items.

17. The non-transitory computer-readable storage medium of claim 16, storing additional instructions which result in the method further comprising:
receiving, from a client device, a request to purchase a particular item;
updating the server listing of items to reflect the purchase of the particular item and a hash value specific to a version of the particular item; and
sending the particular item to the client device along with metadata identifying the particular item and the hash value.

18. The non-transitory computer-readable storage medium of claim 16, storing additional instructions which result in the method further comprising:
receiving, from a different client device, an additional client listing of items purchased from the online store representing the last known listing of items purchased from the online store and associated with the user account, each item in the listing of items being associated with a respective third hash value;
determining an additional difference between the respective first hash value and the respective third hash value; and
sending, to the different client device, metadata identifying items present in the server listing of items that are not in the additional client listing of items.

19. The non-transitory computer-readable storage medium of claim 18, further comprising updating the server listing of items based on an item in at least one of the client listing of items and the additional client listing of items, wherein the item is not in the server listing of items.

20. The non-transitory computer-readable storage medium of claim 16, wherein the respective first hash value and the respective second hash value are based on at least one of an item ID, version information, and metadata.
